(19) United States
(12) Patent Application Publication
(10) Pub. No.: US 2003/0042188 A1
(43) Pub. Date: Mar. 6, 2003

(54) Apparatus for purification of nucleic acids

(76) Inventors: Christoph Ritt, Hilden (DE); Jie Kang, Mettmann (DE)

Correspondence Address: Leon R. Yankwich, Esq, YANKWICH & ASSOCIATES, 201 Broadway, Cambridge, MA, 02139, US

(21) Appl. No.: 09/971,425

(22) Filed: Oct. 5, 2001

(30) Foreign Application Priority Data
Aug. 29, 2001 (DE) DE 201 14 079.9

(51) Int. Cl. B01D 15/08

(52) U.S. Cl. 210/198.2; 210/321.87; 210/500.26; 422/70

(57) ABSTRACT

An apparatus is disclosed for the purification of bio-molecules, especially nucleic acids, comprising a column body with inlet and outlet opening and at least one membrane disposed therein, preferably a silica membrane. Bio-molecules such as isolated nucleic acids are recovered with less dilution and requiring less concentration of the recovery solution by employing a membrane that is 1% to 57% less than the internal diameter of the purification column.

### FIELD OF THE INVENTION

The invention relates to an apparatus for the purification of bio-molecules, especially nucleic acids, comprising a column body with inlet and outlet opening and at least one membrane disposed therein, preferably a silica membrane.

### BACKGROUND OF THE INVENTION

Chromatographic purification by means of silica technology using chaotropic salts (Vogelstein and Gillespie, 1979) is a widespread technology for isolating and purifying nucleic acids from mixtures. With this method, the nucleic acids are isolated from a biological sample by adsorption of the nucleic acids on a silica surface in the presence of chaotropic salts and are then eluted from this surface.

Simple and rapid implementation of the purification of nucleic acids is attained by the use of chromatographic columns with installed silica membranes. The utilized membranes or silica membranes are well known from the prior art.

The diameter of the utilized silica membranes is here always selected so that it is either equal or greater than the internal diameter of the column body. This prevents the solution which contains the nucleic acid from passing without the nucleic acid binding to the membrane. Such a bypass of the membrane by the solution which contains the nucleic acid would naturally mean the that the nucleic acid would not be available for the subsequent measures.

However, membranes with a diameter which is equal or greater than the internal diameter of the column have the disadvantage that the nucleic acid bound to the membranes must be eluted from the membrane with relatively large volumes of elution buffer.

The inevitable consequence of this is that the purified and eluted nucleic acid is present in a relatively large volume of elution buffer, so that it is in too diluted a concentration for some subsequent molecular biological applications and must be concentrated further. This means more work for the user and a not-inconsiderable time requirement.

### SUMMARY OF THE INVENTION

Hence the object of the invention is to overcome the disadvantages known from the prior art and to provide an apparatus which is configured so that the nucleic acid bonded to a membrane can be extracted with the smallest possible amount of elution agent.

The invention solves this task by provision of an apparatus comprising a column body with an inlet and an outlet opening and at least one membrane disposed therein, characterized in that the external diameter of the membrane is 1%-57%, preferably 7%-29%, especially preferably 10%-20% smaller than the internal diameter of the column body.

The reduction in the external diameter of the membrane(s) in the invention according to the invention leads to a reduction in the dead volume when eluting the bound nucleic acid from this membrane.

The apparatus according to the invention can be used in the isolation of nucleic acids such as DNA, RNA or oligonucleotides from agarose gels or polyacrylamide gels, from nucleic acid-modifying reactions such as e.g. labelling, restriction, PCR or RT-PCR reactions and in the isolation of e.g. genomic DNA, plasmid DNA, RNA, viral RNA/DNA from all biological samples.

In a preferred embodiment example, the isolation takes place on a porous or non-porous membrane which contains SiO₂. The membrane which contains SiO₂ can comprise glass, silica or modified glass or silica.

### BRIEF DESCRIPTION OF THE DRAWINGS

FIG. 1 shows a preferred embodiment of the apparatus according to the invention, comprising a hollow body with an inlet and an outlet opening. A membrane 2 is disposed between a support 3 and a fixing apparatus 1.

FIG. 2 describes a further preferred embodiment of the apparatus according to the invention, wherein a self-supporting membrane, attached by a fixing apparatus 1, is disposed in the hollow body with an inlet and an outlet opening.

FIG. 3 shows a further preferred embodiment of the apparatus according to the invention, wherein one or more membranes 2, disposed between a support 3 and a fixing apparatus 1, are disposed in the hollow body with an inlet and an outlet opening.

FIG. 4 shows the DNA concentration, dependent on the membrane diameter.

FIG. 5 shows the RNA concentration, dependent on the membrane diameter.

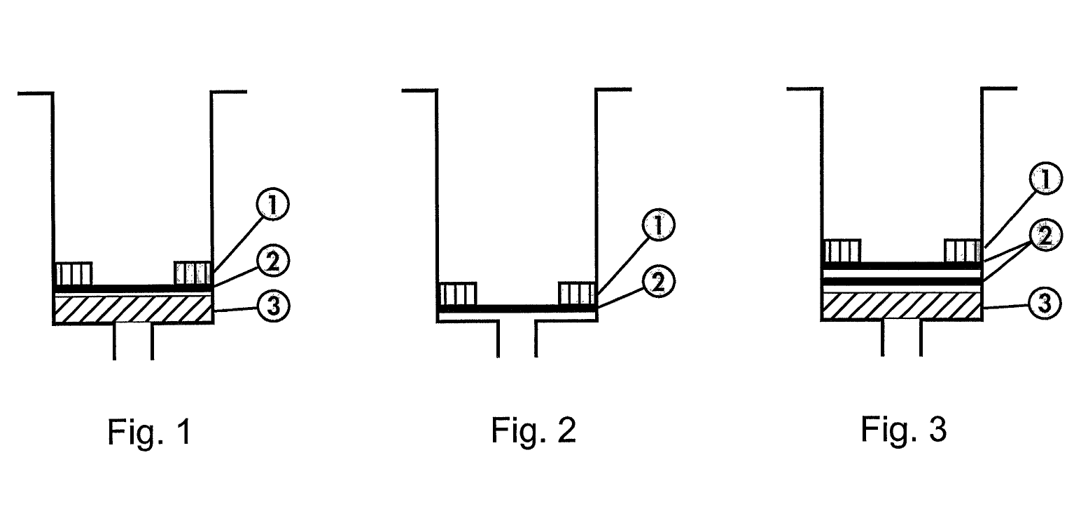

The hollow body is preferably cylindrical and comprises polypropylene (PP), polyethylene (PE), polymethylmethacrylate (PMMA), polytetrafluoroethylene (PTFE), polyester (PET), polystyrene, SAN or other plastics. Glass is also conceivable. The support 3 preferably comprises porous membranes or filters, made of plastic such as polypropylene (PP), polyethylene (PE), polytetrafluoroethylene (PTFE), polyvinylidenedifluoride (PVDF), polyethersulphone (PES), nylon or other plastics. Porous membranes or filters of sintered glass (frits), glass or ceramic are also suitable.

The fixing apparatus 1 can preferably be a porous disc or a ring of, for example, sintered glass or plastic.

In a preferred embodiment of the invention according to FIG. 3, the internal diameter of the polypropylene (PP) column body is 7 mm and the external diameter of the installed membranes is e.g. 6.0 mm or 5.0 mm, which denotes a reduction in the external diameter of the membrane of 14.3% or 2.86%. A porous silica membrane is preferably used which has a pore size of 0.5 to 5 μm, especially preferably 0.7 to 3 μm and most especially preferably 0.7 to 1.5 μm.

If such an apparatus for purifying nucleic acids according to Example 1 is used, it is possible by this reduction in the internal diameter of the membrane(s) to reduce the elution volume to 10 μl or 5 μl without accepting high losses in the absolute nucleic acid yield.

### EXAMPLE 1

### Purification of PCR Fragments with 500 bp

100 μl of a PCR amplification product are mixed with 500 μl buffer, containing 3.5 M GuHCl (guanidinium hydrochloride) and 30% (w/v) ethanol and pipetted into an apparatus according to the invention. The DNA binds to the silica membrane and is eluted with 5, 10 or 50 μl after washing. A cylindrical column body with an internal column diameter of 7 mm and silica membranes with external diameters of 7.5 mm, 6 mm and 5 mm are used.

3 μg of a 500 bp fragment are purified in each case, wherein elution is carried out with 50 μl (with a 7.5 mm membrane diameter), 10 μl (with a 6 mm membrane diameter) or 5 μl (with a 5 mm membrane diameter).

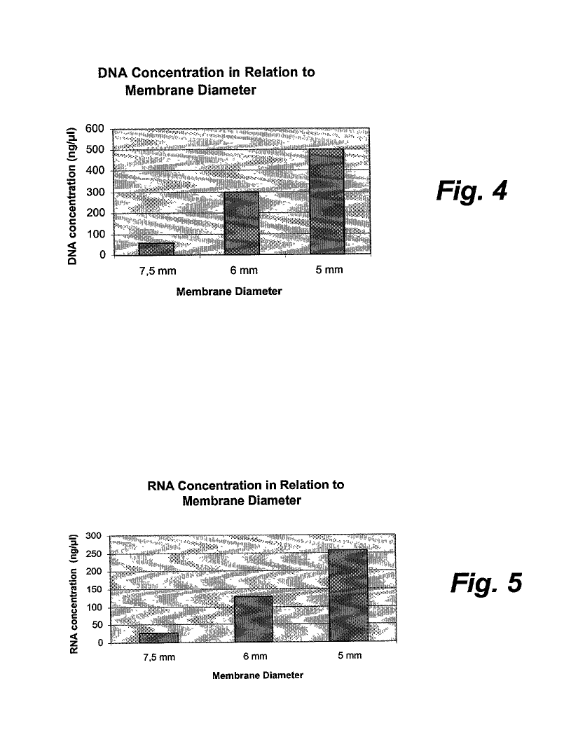

FIG. 4 shows that the reduction of the membrane diameter with constant internal diameter of the column body allows a reduction in the volume of elution agent and leads to a higher DNA concentration.

### EXAMPLE 2

### Isolation of RNA from HeLa Cells

2 μg of total RNA from HeLa cells in a volume of 50 μl was mixed with 350 μl buffer, containing 2 M guanidinium thiocyanate and 30% (w/v) ethanol and pipetted into an apparatus according to the invention. The RNA binds to the silica membrane and is eluted with 5, 10 or 50 μl elution buffer after washing.

A cylindrical column body with an internal column diameter of 7 mm and silica membranes with external diameters of 7.5 mm, 6 mm and 5 mm are used.

2 μg of total RNA from HeLa cells are purified in each case, wherein elution is carried out with 50 μl (with a 7.5 mm membrane diameter), 10 μ1 (with a 6 mm membrane diameter) or 5 μl (with a 5 mm membrane diameter).

FIG. 5 shows that the reduction of the membrane diameter with constant internal diameter of the column body allows a reduction in the volume of elution agent and leads to a higher RNA concentration.

1. An apparatus comprising a column body with an inlet and an outlet opening and at least one membrane disposed therein, characterized in that the external diameter of the membrane is smaller by 1%-57% than the internal diameter of the column body.

2. An apparatus according to claim 1, comprising a column body with an inlet and an outlet opening and at least one membrane disposed therein, characterized in that the external diameter of the membrane is smaller by 7%-29% than the internal diameter of the column body.

3. An apparatus according to claim 2, comprising a column body with an inlet and an outlet opening and at least one membrane disposed therein, characterized in that the external diameter of the membrane is smaller by 10%-20% than the internal diameter of the column body.

4. An apparatus according to one of claims 1 to 3, characterized in that the membrane(s) is/are one or more porous or non-porous silica membrane(s).

5. An apparatus according to claim 4, characterized in that the internal diameter of the column body is 7 mm and the external diameter of the therein-installed membrane(s) is 6 mm.

6. An apparatus according to claim 4, characterized in that the internal diameter of the column body is 7 mm and the external diameter of the therein-installed membrane(s) is 5 mm

7. An apparatus according to claim 4, characterized in that a porous silica membrane with a pore size of 0.5 μm to 5 μm is used.

8. An apparatus according to claim 4, characterized in that a porous silica membrane with a pore size of 0.7 μm to 3 μm is used.

9. An apparatus according to claim 4, characterized in that a porous silica membrane with a pore size of 0.7 μm to 1.5 μm is used.
